(19) United States
(12) Patent Application Publication
(10) Pub. No.: US 2013/0063334 A1
(43) Pub. Date: Mar. 14, 2013

(54) REFLECTIVE DISPLAYS, SUB-PIXELS FOR REFLECTIVE DISPLAYS AND METHODS TO CONTROL REFLECTIVE DISPLAYS

(71) Applicants: Gary Gibson, Palo Alto, CA (US); Xia Sheng, Palo Alto, CA (US)

(72) Inventors: Gary Gibson, Palo Alto, CA (US); Xia Sheng, Palo Alto, CA (US)

(21) Appl. No.: 13/696,533

(22) PCT Filed: May 6, 2010
(86) PCT No.: PCT/US2010/033911

§ 371 Date: Nov. 6, 2012

(51) Int. Cl. G09G 3/34

(52) U.S. Cl. 345/107

(57) ABSTRACT

Reflective displays, sub-pixels for reflective displays and methods to control reflective displays are disclosed. An example sub-pixel for a reflective display disclosed herein comprises a first active shutter layer to provide a first adjustable light transmission, a second active shutter layer to provide a second adjustable light transmission, the first and second active shutter layers being independently controllable, and a luminescent layer positioned interior to at least one of the first and second active shutter layers, the luminescent layer to emit light having a color corresponding to the sub-pixel.

### BACKGROUND

Many modern electronic devices, such as electronic book readers, personal digital assistants, etc., utilize reflective displays to achieve good visibility even in bright ambient light conditions while maintaining low power consumption. Unlike an active display that powers a backlight to illuminate the display to generate a display image, a conventional reflective display reflects ambient light to generate the display image, resulting in lower power consumption. Reflective displays can be monochrome or color displays. Color reflective displays typically employ pixels each containing a group of side-by-side sub-pixels having different colors or containing a group of vertically stacked cells having different colors to produce colored pixels. However, due to their limited brightness, contrast and color gamuts, prior color reflective displays have not experienced the commercial success of monochromatic reflective displays.

### BRIEF DESCRIPTION OF THE DRAWINGS

FIG. 1 is block diagram of an example device including an example reflective display utilizing luminescent enhancement and multiple active layers constructed in accordance with the teachings of this disclosure.

FIGS. 2A-E collectively illustrate a first example sub-pixel arrangement for implementing the reflective display of FIG. 1.

FIG. 3 illustrates a second example sub-pixel arrangement for implementing the reflective display of FIG. 1

FIGS. 4A-E collectively illustrate a third example sub-pixel arrangement for implementing the reflective display of FIG. 1.

FIG. 5 illustrates a fourth example sub-pixel arrangement for implementing the reflective display of FIG. 1.

FIG. 6 illustrates a fifth example sub-pixel arrangement for implementing the reflective display of FIG. 1.

FIG. 7 illustrates an example display control system for controlling the reflective display of FIG. 1.

FIG. 8 is a flowchart representative of example machine readable instructions that may be executed to implement the display controller of FIG. 7.

FIG. 9 is a block diagram of an example processing system that may execute the example machine readable instructions of FIG. 8 to implement the display controller of FIG. 7.

### DETAILED DESCRIPTION

Reflective displays, sub-pixels for reflective displays and methods to control reflective displays are disclosed. An example reflective display described herein includes a plurality of pixels. Each pixel includes multiple (e.g., such as three or more, but possibly fewer) sub-pixels, and each sub-pixel corresponds to a different primary color. At least one of the sub-pixels in the display includes a first active shutter layer, a second active shutter layer, a luminescent layer positioned interior to at least one of the first and second active shutter layers, and a mirror layer positioned interior to the luminescent layer. The first active shutter layer (e.g., which may be an outermost layer of the display) provides a first adjustable light transmission between a clear state (e.g., corresponding to the first active shutter layer being substantially transparent) and a black state (e.g., corresponding to the first active shutter layer being substantially opaque), with zero or more intermediate transmission states therebetween. The second active shutter layer (e.g., which may be positioned between the first active shutter layer and the luminescent layer) is independently controllable relative to the first active shutter layer and provides a second adjustable light transmission between a clear state (e.g., corresponding to the second active shutter layer being substantially transparent) and a white state (e.g., corresponding to the second active shutter layer being substantially light scattering), with zero or more intermediate transmission states therebetween. The luminescent layer emits light having a color corresponding to the particular sub-pixel. The mirror layer reflects light passing through the first active shutter layer, the second active shutter layer and the luminescent layer, and also reflects light emitted by the luminescent layer. In some examples, a second sub-pixel in the display (e.g., corresponding to the color blue) does not include the luminescent layer and the mirror layer and, instead, includes a color-reflecting interlayer mirror positioned between the first active shutter layer and the second active shutter layer.

The example reflective displays utilizing luminescent enhancement and multiple active layers disclosed herein can provide significant advantages over prior color reflective displays. As noted above, color reflective displays typically employ groups of side-by-side sub-pixels having different colors or groups of vertically stacked cells having different colors to produce colored pixels. In such prior side-by-side sub-pixel implementations, filters positioned over a group of adjacent sub-pixels are used to determine the color of a pixel. For example, filters can be used to yield three adjacent sub-pixels corresponding respectively to three primary colors (e.g., such as red, green and blue, or cyan, yellow and magenta), or four adjacent sub-pixels corresponding respectively to the three primary colors and also a white sub-pixel to improve display brightness and contrast). However, each pixel in such prior side-by-side sub-pixel displays utilizes and reflects only a fraction of the incident light. For example, a pixel in a prior display employing N equal area sub-pixels in a side-by-side arrangement utilizes and reflects less than 1/N of the available incident light in each of the color bands modulated by the sub-pixels. As a result, the overall side-by-side sub-pixel display also utilizes and reflects only a small fraction of incident light, resulting in a reflective color display that can be unacceptably dim.

Prior color reflective displays employing groups of vertically stacked cells can also suffer from limitations that make them commercially unattractive. In a prior implementation employing vertically stacked cells, each color band is modulated in a separate electro-optic layer. Typically, at least three such layers are stacked to achieve the three primary colors in a particular pixel. However, displays having multiple stacked electro-optic layers to implement the vertically stacked cells are generally more expensive to manufacture than side-by-side sub-pixel displays. Additionally, vertically stacked cell displays can suffer from absorptive losses and stray reflections in their many electrode and substrate layers, thereby limiting the brightness and contrast that can be achieved by such displays.

In contrast, in addition to light reflection, the example reflective displays disclosed herein utilize luminescent enhancement in a side-by-side sub-pixel arrangement to improve the efficiency with which the available ambient light is used relative to many prior side-by-side or vertically stacked cell displays. By using the available ambient light inure efficiently, the example disclosed reflective displays are able to achieve increased brightness and contrast relative to such prior color reflective displays. Additionally, multiple (e.g., such as two) active shutter layers, which are not present in such prior color reflective displays, are employed by the example disclosed reflective displays to further increase brightness and contrast, thereby achieving improved color gamuts. Furthermore, the example disclosed reflective displays employing just two electro-optic shutter layers can enhance the color gamut achievable using luminescence-enhanced side-by-side sub-pixel architectures without the need for the three stacked electro-optic layers employed in typical layered designs. Thus, the example disclosed reflective displays can be less costly to manufacture while achieving the improved brightness, contrast and color gamut performance.

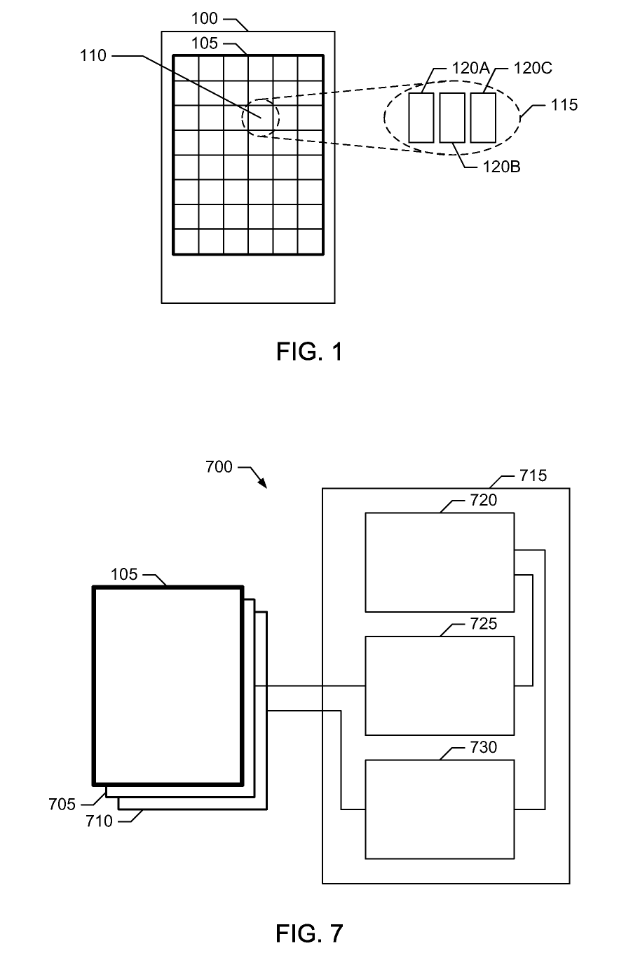

Turning to the figures, a block diagram of an example device 100 that includes an example reflective display 105 utilizing luminescent enhancement and multiple active layers as disclosed herein is illustrated in FIG. 1. The device 100 can be any type of device, appliance, equipment, etc., capable of presenting information in the form of text images, video, etc. For example, the device 100 can correspond to an electronic book (e-book) reader, a personal digital assistant (PDA), a notebook computer, a smartphone or other mobile or cellular telephone, a consumer appliance refrigerator, microwave, oven, etc.), measurement/test equipment, etc.

The reflective display 105 illustrated in FIG. 1 includes an example array of pixels 110. Each pixel 110 is capable of displaying black, white, one or more primary colors and one or more mixtures of primary colors. To display color, each pixel 110 of the display 105 includes a side-by-side sub-pixel arrangement 115 containing three sub-pixels 120A, 120B and 120C. Although the sub-pixel arrangement 115 in the illustrated example includes the three sub-pixels 120A-C, other examples of the display 105 can include sub-pixel arrangements 115 containing more or fewer sub-pixels.

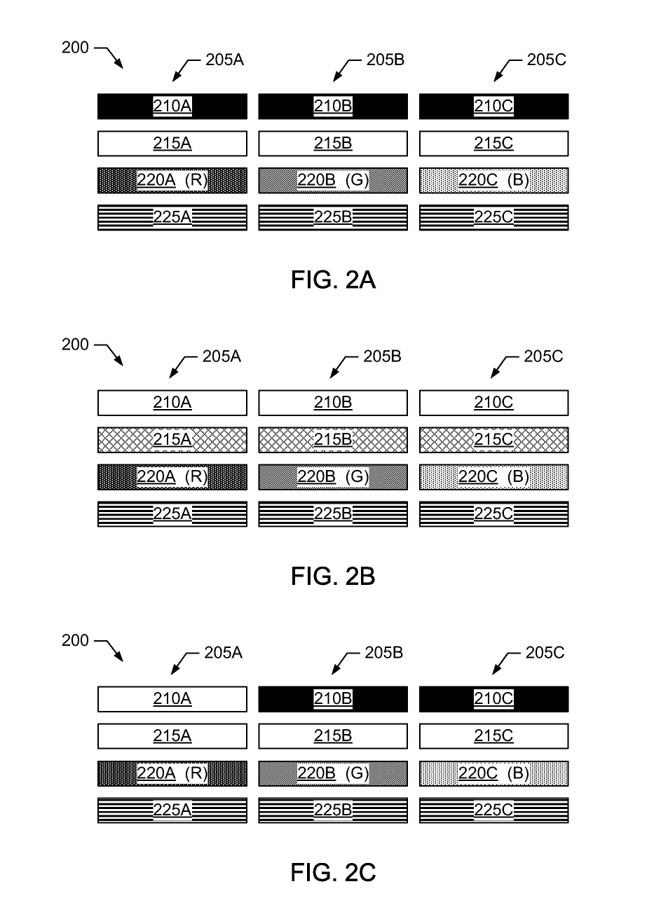

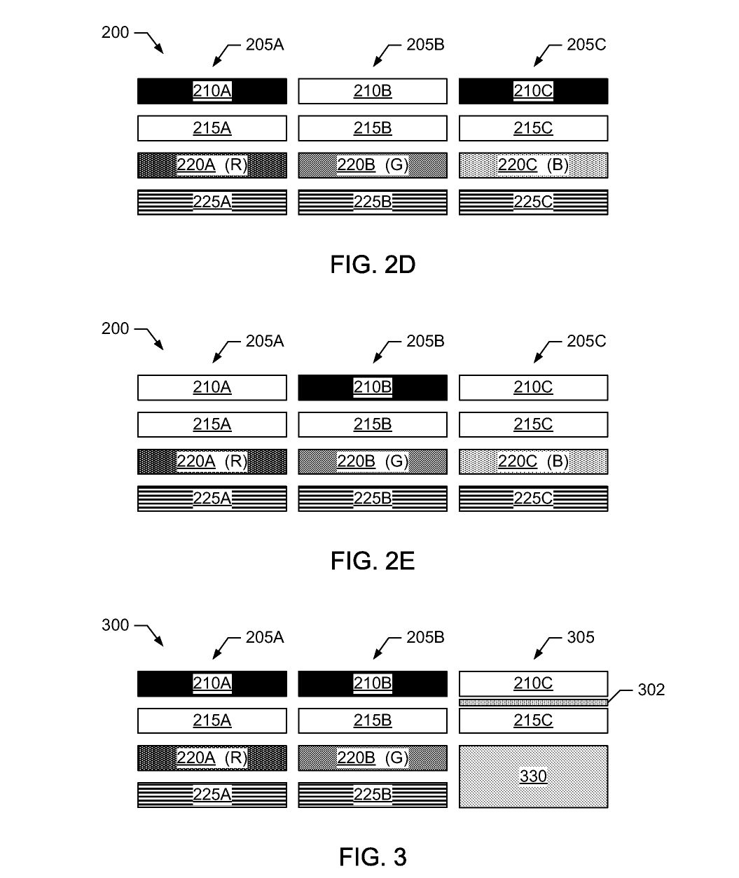

A first example sub-pixel arrangement 200 that may be used to implement the sub-pixel arrangement 115 of the display 105 is illustrated in FIGS. 2A-E. Each of FIGS. 2A-E illustrates a different operating state (e.g., overall color state) for the sub-pixel arrangement 200. In the example of FIGS. 2A-E, the sub-pixel arrangement 200 includes three example sub-pixels, 205A, 205B and 205C. The three sub-pixels 205A-C can be arranged in aside-by-side configuration as illustrated in the figures, or in any other geometric configuration appropriate for a particular implementation. Each sub-pixel 205A-C of the sub-pixel arrangement 200 includes two example active electro-optic shutter layers, labeled 210A-C and 215A-C, respectively. Each sub-pixel 205A-C also includes a respective example luminescent layer 220A-C and a respective example mirror layer 225A-C. In the illustrated example, the mirror layer 225A-C is interior to the luminescent layer 220A-C, which is interior to the two active electro-optic shutter layers 210A-C and 215A-C.

As the term is used herein, a first layer of a display is interior to a second layer of a display if the first layer is positioned below the second layer when the display is oriented with the viewing surface facing up. Also, an outermost layer of a set of layers in the display corresponds to the top layer of the set when the display is oriented with the viewing surface facing up, and an innermost layer of the set of layers corresponds to the bottom layer of the set when the display is oriented with the viewing surface facing up.

In the illustrated example, the luminescent layer 220A-C of each sub-pixel 205A-C is implemented by a luminescent film containing luminophores. Luminophores are atoms or atomic groupings in chemical compounds that manifest luminescence or, in other words, absorb light in an absorption spectrum and emit light in an emission spectrum, with the emission spectrum designed to achieve the color corresponding to the respective sub-pixel 205A-C. Examples of luminophores that can be used to implement the luminescent layer 220A-C include, but are not limited to, luminescent dye molecules, polymers or inorganic phosphor materials (e.g., such as Y₂O₃:Eu particles for red), or pigment particles or nanostructered particles incorporating such luminescent dye molecules, polymers or inorganic phosphor materials, etc. To obtain an adequate absorption spectrum, combinations of luminophores can be used that cover the desired absorption band. The luminophores included in such a combination can, for example, have different absorption bands and independently emit in approximately the same emission band, or some of the luminophores can transfer their absorbed energy to other luminophores through a resonant energy transfer processes, such as via Förster exchange. In the latter case, the emission band of the donor luminophores overlaps the absorption band of the acceptor luminophores. Multiple luminophore species can be used to sequentially transfer energy to the final donor. An advantage of this approach relative to using multiple luminophore species each emitting directly is that only the final luminophore emitter is to have high internal emission efficiency. The emission efficiency of the other donor luminophore species can be relatively low as long as the energy they absorb is rapidly transferred to an acceptor before non-radiative recombination occurs.

In some examples, the luminescent film implementing the luminescent layer 220A-C contains the luminophores in a solid matrix or a liquid matrix, with the matrix material being substantially transparent at wavelengths that are to be absorbed or emitted by the luminophores,

Generally, the luminophores included in the luminescent layer 220A-C down-convert absorbed light for emission such that the absorption spectrum includes a first band of light wavelengths different (e.g., higher in frequency for down-conversion, and lower in frequency for up-conversion) than, but possibly overlapping, a second band of light wavelengths included in the emission spectrum (e,g., due to Stokes shift). For example, in the sub-pixel arrangement 200, the sub-pixel 205A corresponds to the color red, the sub-pixel 205B corresponds to the color green and the sub-pixel 205C corresponds to the color blue. In such an example, the luminescent layer 220A of the red sub-pixel 205A contains red luminophores, for example, having an emission spectrum including wavelengths in the red portion of the light spectrum, and an absorption spectrum including all visible and possibly some ultraviolet (e.g., near ultra violet) wavelengths shorter (e.g., higher in frequency) than the wavelengths included in the red luminophore emission spectrum. Similarly, the luminescent layer 220B of the green sub-pixel 205B contains green luminophores, for example, having an emission spectrum including wavelengths in the green portion of the light spectrum, and an absorption spectrum including wavelengths in the blue and near ultraviolet (UV) portions of the light spectrum, which are shorter (e.g., higher in frequency) than the wavelengths included in the green luminophore emission spectrum. In the illustrated example of FIGS. 2A-E, the luminescent layer 220C of the blue sub-pixel 205C contains blue luminophores having an emission spectrum including wavelengths in the blue portion of the light spectrum, and an absorption spectrum including wavelengths in the deeper blue and near ultraviolet (UV) portions of the light spectrum, which are shorter (e.g., higher in frequency) than the wavelengths included in the blue luminophore emission spectrum.

In the illustrated example of FIGS. 2A-E, the luminescent film used to implement each luminescent layer 220A-C is deposited over the respective mirror layer 225A-C implementing the respective sub-pixel 205A-C. The mirror layers 225A-C are included in the sub-pixel arrangement 200 to reflect the light emitted towards the interior of the display by their respective luminescent layers 220A-C, as well as the light passing through (and, thus, not absorbed by) the respective luminescent layers 220A-C (as well as passing through the shutter layers 210A-C and 215A-C), to thereby increase, or boost, the overall intensity of the color provided by each respective sub-pixel 205A-C. Each mirror layer 225A-C can be implemented by, for example, a wavelength-selective mirror, a broadband mirror, a combination of a color filter and a broadband mirror, etc. The same or different mirror implementations can be used for each mirror layer 225A-C included in the sub-pixel arrangement 200.

For example, the mirror layer 225A of the red sub-pixel 205A can be implemented by a broadband mirror (e.g., which is usually simpler to design and implement than a wavelength-selective mirror) because the only wavelengths not absorbed by the red emitting luminophores of the luminescent layer 220A are in the red to infrared (IR) region of the light spectrum. Thus, the only light reflected by the broadband mirror will also be in the red to IR spectrum, which will boost the intensity of the red light provided by the red sub-pixel 205A.

For the mirror layer 225B of the green sub-pixel 205B, a wavelength-selective mirror or a combination of a color filter and a broadband mirror can be used to reflect green wavelengths emitted by the luminescent layer 220B, as well as the other wavelengths in the green region of the light spectrum that are not absorbed by the green emitting luminophores of the luminescent layer 220B. In some examples, the reflection band of the mirror layer 225B can be increased (e.g., to simplify mirror design and implementation) to also be reflective in the blue and/or UV regions if these regions are absorbed by the luminophores of the luminescent layer 220B. If a Bragg mirror is used to implement the mirror layer 225B, being able to increase the mirror's reflection band relaxes the design specification of the Bragg mirror. Similarly, if a combination of a color filter and a broadband mirror is used to implement the mirror layer 225B, the set of possible materials that can be used to implement the color filter broadens by allowing the reflection band to include blue and/or UV wavelengths, as well as the desired green wavelengths,

A wavelength-selective mirror or a combination of a color filter and a broadband mirror can also be used to implement the mirror layer 225C of the blue sub-pixel 205C. However, in some examples, the blue emitting luminophores of the luminescent layer 220C do not absorb visible light outside the blue region (and possibly UV region) and, thus, allow this other colored light to pass through to the mirror layer 225C. In such examples, the reflection band of the mirror layer 225C is restricted to the blue region (and possibly UV region) of the light spectrum to avoid contamination of blue sub-pixel 205C with colors other than blue.

In the illustrated example of FIGS. 2A-E, the outermost (e.g., top) active electro-optic shutter layer 210A-C for each respective sub-pixel 205A-C provides adjustable light transmission capable of being independently switched (e.g., relative to the other outermost shutter layers 210A-C for the other sub-pixels 205A-C and/or the other innermost shutter layers 215A-C for any of the sub-pixels 205A-C) between a clear transmission state and a black (or opaque) transmission state by, for example, application of different electrical voltages or currents associated with the respective states. Accordingly, the outermost active electro-optic shutter layers 210A-C are also referred to as the black-clear shutter layers 210A-C or the K/clr shutter layers 210A-C, where “K” represents black (or opaque), and “clr” represents clear. The clear state corresponds to the respective sub-pixel 205A-C having transparent (e.g., almost completely transparent or at least substantially transparent) light transmission and, thus, allowing light to pass through to, and to be emitted and reflected from, the lower layers of the sub-pixel 205A-C. The black state corresponds to the respective sub-pixel 205A-C having opaque almost completely opaque or at least substantially opaque) light transmission and, thus, blocking light from passing through to, and from being emitted and reflected from, the lower layers of the sub-pixel 205A-C. In the figures, the black state is depicted as a solid black shaded box, and the clear state is depicted as an unshaded box. In sonic examples, the active electro-optic shutter layers 210A-C for one or more of the respective sub-pixels 205A-C support switching among the clear state, the black state, and one or more intermediate monochromatic (e.g., gray) light transmission states between the clear state and the black state. Example technologies that may be used to implement the active electro-optic shutter layers 210A-C include, but are not limited to, black/clear dichroic liquid crystal (LC) guest-host systems, electrophoretic (EP) systems, electro-wetting layers, electrofluidic layers. etc.

The innermost (e.g., bottom) active electro-optic shutter layer 215A-C for each respective sub-pixel 205A-C illustrated in FIGS. 2A-E provides adjustable light transmission capable of being independently switched (e.g., relative to the other innermost shutter layers 215A-C for the other sub-pixels 205A-C and/or the other outermost shutter layers 210A-C for any of the sub-pixels 205A-C) between a clear transmission state and a white (or broadband visible light scattering) transmission state by, for example, application of different electrical voltages or currents associated with the respective states. Accordingly, the innermost active electro-optic shutter layers 215A-C are also referred to as the white-clear shutter layers 215A-C or the W/clr shutter layers 215A-C, where “W” represents white, and “clr” represents clear. As noted above, the clear state corresponds to the respective sub-pixel 205A-C having transparent (e.g., almost completely transparent or at least substantially transparent) light transmission and, thus, allowing light to pass through to, and to be emitted and reflected from, the lower layers of the sub-pixel 205A-C. However, in contrast with the black state, the white state corresponds to the respective sub-pixel 205A-C having light transmission that causes light scattering (e.g., almost complete light scattering or at least substantial light scattering) and, thus, causes substantially white light to be reflected by the sub-pixel 205A-C. In the figures, the white state is depicted as a cross-hatched shaded box, and the clear state is depicted as an unshaded box. In some examples, the active electro-optic shutter layers 215A-C for one or more of the respective sub-pixels 205A-C support switching among the clear state, the white state, and one or more intermediate light transmission states between the clear state and the white state. Example technologies that may be used to implement the active electro-optic shutter layers 215A-C include, but are not limited to, electrophoretic (EP) systems containing broadband scattering particles (e.g., such as titania), polymer-dispersed liquid crystals (PDLC) systems, electro-wetting layers containing broadband scattering particles, electrofluidic layers containing broadband scattering particles, etc.

As noted above, a different operating state (e.g., overall color state) for the sub-pixel arrangement 200 is depicted in each of FIGS. 2A-E. For example, FIG. 2A depicts the sub-pixel arrangement 200 operating in a black state (also referred to as a black reflecting state) in which the black-clear shutter layers 210A-C for all of the sub-pixels 205A-C are set to black (also referred to as closing the black-clear shutters 210A-C) by application of the appropriate electrical voltages/currents. In the black operating state, the black-clear shutter layers 210A-C absorb all (or substantially all) visible light and, thus, reflect no (or substantially no) visible light, thereby causing all of the sub-pixels 205A-C to “reflect” black.

FIG. 2B depicts the sub--pixel arrangement 200 operating in a white state (also referred to as a white reflecting state) in which the black-clear shutter layers 210A-C for all of the sub-pixels 205A-C are set to clear (e.g., also referred to as opening the black-clear shutter 210A-C) by application of the appropriate electrical voltage/current. Additionally, the white-clear shutter layers 215A-C for all of the sub-pixels 205A-C are set to white (e.g., also referred to as closing the white-clear shutters 215A-C) by application of the appropriate electrical voltages/currents. In the white operating state, all of the sub-pixels 205A-C reflect white.

FIG. 2C depicts the sub--pixel arrangement 200 operating in a red state in which the black-clear shutter layer 210A for the red sub-pixel 205A (e.g., the active sub-pixel) is set to clear (e.g., opened) and the black-clear shutter layers 210B-C for the green and blue sub-pixels 205B-C (e.g., the inactive sub-pixels) are set to black (e.g., closed) by application of the appropriate electrical voltages/currents. Additionally, the white-clear shutter layers 215A-C for all of the sub-pixels 205A-C are set to clear (e.g., also referred to as opening the white-clear shutters 215A-C) by application of the appropriate electrical voltages/currents. Setting the white-clear shutter layer 215A of the red sub-pixel 205A (e.g., the active sub-pixel) to clear allows light to pass through to, and to be emitted and reflected from, the lower layers of the red sub-pixel 205A. Additionally, setting the white-clear shutter layers 215B-C of the green and blue sub-pixels 205B-C (e.g., the inactive sub-pixels) to clear reduces the reflectivity of the combined shutter layers, causing the green and blue sub-pixels 205B-C to be a darker black than if the white-clear shutter layers 215B-C were set to the White state. Thus, in the red operating state, the red sub-pixel 205A is active and provides the red light emitted by the luminescent layer 220A and reflected by the minor layer 225A.

FIG. 2D depicts the sub-pixel arrangement 200 operating in a green state in which the black-clear shutter layer 210A for the green sub-pixel 205B (e.g., the active sub-pixel) is set to clear (e.g., opened) and the black-clear shutter layers 210A and 210C for the red and blue sub-pixels 205A and 250C (e.g., the inactive sub-pixels) are set to black (e.g., closed) by application of the appropriate electrical voltages/currents. Additionally, the white-clear shutter layers 215A-C for all of the sub-pixels 205A-C are set to clear (e.g., opened) by application of the appropriate electrical voltages/currents. In the green operating state, the green sub-pixel 205B is active and provides the green light emitted by the luminescent layer 220B and reflected by the mirror layer 225B.

FIG. 2E depicts the sub-pixel arrangement 200 operating in a magenta state in which the black-clear shutter layer 210A for the red sub-pixel 205A (e.g., an active sub-pixel) is set to clear (e.g., opened), the black-clear shutter layer 210C for the blue sub-pixel 205C (e.g., an active sub-pixel) is set to clear (e.g., opened), and the black-clear shutter layer 210B for the green sub-pixel 205B (e.g., an inactive sub-pixel) is set to black (e.g., closed) by application of the appropriate electrical voltages/currents. Additionally, the white-clear shutter layers 215A-C for all of the sub-pixels 205A-C are set to clear (e.g., opened) by application of the appropriate electrical voltages/currents. In the magenta operating state, the red sub-pixel 205A and blue sub-pixel 205C are both active, thereby causing the red light emitted by the luminescent layer 220A and reflected by the mirror layer 225A to be mixed with the blue light emitted by the luminescent layer 220C and reflected by the mirror layer 225C to form magenta.

As illustrated in the examples of FIGS. 2A-B, the sub-pixel arrangement 200 can be placed into a black reflecting state or a white reflecting state. This capability of the sub-pixel arrangement 200 can improve the white lightness and the black-white contrast of the display 105 relative to prior reflective displays, which are characteristics often used to judge display quality. Additionally, the colored states of the sub-pixel arrangement 200, such as those depicted in FIGS. 2C-E, are enhanced relative to prior reflective displays through the recycling of otherwise wasted light by the photoluminescence exhibited by the luminescent layers 220A-C.

In average room lighting, the amount of deep blue and near-UV light may be relatively low. As such, the blue luminophores used to implement the luminescent layer 220C of the blue sub-pixel 205C may not be able to absorb sufficient energy to warrant their use. To address this issue, a second example sub-pixel arrangement 300 employs an example color-reflecting interlayer mirror 302, instead, of the luminescent layer 220C and the mirror layer 225C, to implement an example blue sub-pixel 305 illustrated in FIG. 3. In the illustrated example, the color-reflecting interlayer mirror 302 is a blue-reflecting interlayer mirror 302 positioned between the black-clear shutter layer 210C and the white-clear shutter layer 215C. The blue-reflecting interlayer mirror 302 can be implemented using, for example, any appropriate wavelength-selective mirror material having a reflection band restricted to the desired color band (e.g., blue in the sub-pixel arrangement 300 of FIG. 3). An example substrate layer 330 is used to fill the space interior to (e.g., below) the white-clear shutter layer 215C. The substrate layer 330 can correspond to any appropriate substrate material, such as the substrate material forming the backing of the display 105. Additionally or alternatively, the substrate layer 330 can be colored black or white depending upon the efficacy of the closed, states of the black-clear shutter layer 210C and, the white-clear shutter layer 215C, and the relative importance of the black reflecting state or the white reflecting state in a particular application.

Table 1 lists design parameters for an example implementation of the sub-pixel arrangement 300 of FIG. 3. It is expected that the sub-pixel arrangement 300 implemented according to Table 1 can achieve a color gamut similar to the Specification for Newspaper Advertising Production (SNAP) standard, which is significantly brighter than the color gamut achievable by many prior color reflective displays.

TABLE 1

| | Red | | Green | | Blue |
|---|---|---|---|---|---|
| Parameter | Sub-Pixel | | Sub-Pixel | | Sub-Pixel |
| Fractional Area | 0.3167 | | 0.3167 | | 0.3167 |
| (Total = 95% due | | | | | |
| to aperture loss) | | | | | |
| Luminophore | 80% | | 80% | | N/A |
| quantum | | | | | |
| efficiency | | | | | |
| Out-coupling | 50% | | 50% | | N/A |
| efficiency for | | | | | |
| upward-emitting | | | | | |
| luminescence | | | | | |
| Peak luminophore | 610 | nm | 550 | nm | N/A |
| emission | | | | | |
| wavelength | | | | | |
| Stokes shift | 45 | nm | 35 | nm | N/A |
| Emission type | Gaussian | | Gaussian | | N/A |
| | with standard | | with standard | | |
| | deviation | | deviation | | |
| | of 25 nm | | of 25 nm | | |
| Interlayer mirror | No | | No | | Yes, with 90% |
| present | | | | | transmission for |
| | | | | | green and red |
| Minor reflection | 570-830 | nm | 520-570 | nm | 340-510 nm |

| | | | |
|---|---|---|---|
| bands | | | |
| Mirror reflectivity | 95% | 95% | 95% |
| Transmission of | Peak = 90% | Peak = 90% | Peak = 90% |
| shutters | Minimum = 10% | Minimum = 10% | Minimum = 10% |

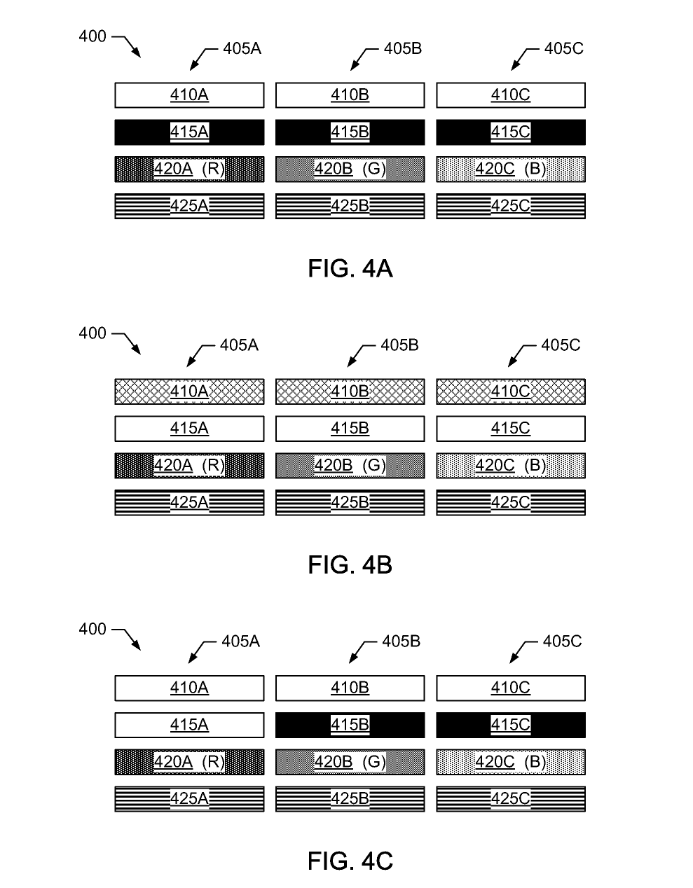

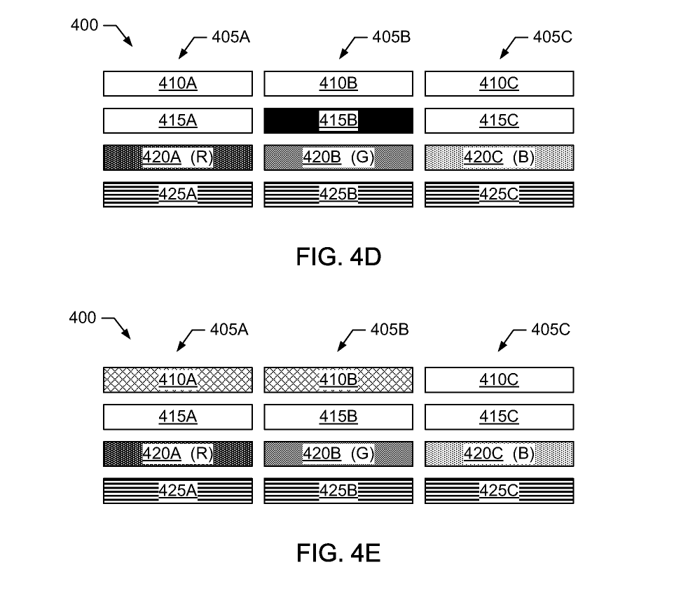

A third example sub-pixel arrangement 400 that may be used to implement the sub-pixel arrangement 115 of the display 105 is illustrated in FIGS. 4A-E. Each of FIGS. 4A-E illustrates a different operating state (e.g., overall color state) for the sub-pixel arrangement 400. Similar to the sub-pixel arrangement 200 of FIGS. 2A-E, the sub-pixel arrangement 400 of FIGS. 4A-E includes three example sub-pixels 405A-C corresponding, respectively, to red, green and blue, with the three sub-pixels 405A-C being arranged in a side-by-side configuration as illustrated in the figures, or in any other geometric configuration appropriate for a particular implementation. Each sub-pixel 405A-C includes a respective example luminescent layer 420A-C and a respective example mirror layer 425A-C. The luminescent layers 420A-C and the mirror layers 425A-C may be similar or identical to the luminescent layers 220A-C and the minor layers 225A-C of the sub-pixel arrangement 200.

The sub-pixel arrangement 400 of FIGS. 4A-E also includes two example active electro-optic shutter layers 410A-C and 415A-C similar or identical to the two example active electro-optic shutter layers 215A-C and 210A-C, respectively, in the sub-pixel arrangement 200 of FIGS. 2A-E. However, placement of the active electro-optic shutter layers 410A-C and 415A-C is reversed relative to the placement of the active electro-optic shutter layers 210A-C and 215A-C in the sub-pixel arrangement 200. More specifically, in the sub-pixel arrangement 400, the outermost (e.g., top) active electro-optic shutter layers 410A-C are white-clear shutter layers 410A-C (or W/clr shutter layers 410A-C) capable of being independently switched between the clear transmission state and the white (e.g., light scattering) transmission state (and, in some examples, one or more intermediate states as well) by, for example, application of different electrical voltages or currents associated with the respective states. The innermost (e.g., bottom) active electro-optic shutter layers 415A-C are black-clear shutter layers 415A-C (or Kick shutter layers 415A-C) capable of being independently switched between the clear transmission state and the black (or opaque) transmission state (and, in some examples, one or more intermediate states as well) by, for example, application of different electrical voltages or currents associated with the respective states. The active electro-optic shutter layers 410A-C and 415A-C of the sub-pixel arrangement 400 may be implemented using similar or identical technology and materials as the active electro-optic shutter layers 215A-C and 210A-C, respectively, of the sub-pixel arrangement 200.

As noted above, a different operating state (e.g., overall color state) for the sub-pixel arrangement 400 is depicted in each of FIGS. 4A-E. For example, FIG. 4A depicts the sub-pixel arrangement 400 operating in the black state in which the white-clear shutter layers 410A-C for all of the sub-pixels 405A-C are set to clear opened) and the black-clear shutter layers 415A-C for all of the sub-pixels 405A-C are set to black (e.g., closed). FIG. 4B depicts the sub-pixel arrangement 400 operating in the white state in which the white-clear shutter layers 410A-C for all of the sub-pixels 405A-C are set to white (e.g., closed.) and the black-clear shutter layers 415A-C for all of the sub-pixels 405A-C are set to clear (e.g., opened). FIG. 4C depicts the sub-pixel arrangement 400 operating in the red state in which the white-clear shutter layers 410A-C for all of the sub-pixels 405A-C are set to clear (e.g., opened), the black-clear shutter layer 415A for the red sub-pixel 405A is set to clear (e.g., opened) and the black-clear shutter layers 415B-C for the green and blue sub-pixels 405B-C are set to black (e.g., closed). FIG. 4D depicts the sub-pixel arrangement 400 operating in the magenta state in which the white-clear shutter layers 410A-C for all of the sub-pixels 405A-C are set to clear (e.g., opened), the black-clear shutter layer 415A for the red sub-pixel 405A is set to clear (e.g., opened), the black-clear shutter layer 415C for the blue sub-pixel 405C is set to clear (e.g., opened), and the black-clear shutter layer 415B for the green sub-pixel 405B is set to black (e.g., closed). FIG. 4E depicts the sub-pixel arrangement 400 operating in a blue-white state in which the black-clear shutter layers 415A-C for all of the sub-pixels 405A-C are set to clear (e.g., opened), the white-clear shutter layer 410C for the blue sub-pixel 405C is set to clear (e.g., opened), and the white-clear shutter layers 410A-B for the red and green sub-pixels 405A-B are set to white (e.g., closed).

Table 2 lists design parameters for an example implementation of the sub-pixel arrangement 400 of FIGS. 4A-E. It is expected that the sub-pixel arrangement 400 implemented according to Table 2 can achieve a color gamut that is brighter (e.g., lighter) than the SNAP standard, but at the possible expense of the darker color states and color saturation.

TABLE 2

| | Red | | Green | | Blue | |
|---|---|---|---|---|---|---|
| Parameter | Sub-Pixel | | Sub-Pixel | | Sub-Pixel | |
| Fractional Area | 0.2 | | 0.27 | | 0.48 | |
| (Total = 95% due | | | | | | |
| to aperture loss) | | | | | | |
| Luminophore | 80% | | 80% | | 80% | |
| quantum | | | | | | |
| efficiency | | | | | | |
| Out-coupling | 50% | | 50% | | 50% | |
| efficiency for | | | | | | |
| upward-emitting | | | | | | |
| luminescence | | | | | | |
| Peak luminophore | 610 | nm | 550 | nm | 470 | nm |

| emission | | | | | |
|---|---|---|---|---|---|
| wavelength | | | | | |
| Stokes shift | 45 | nm | 35 | nm | 25 nm |
| Emission type | Gaussian | | Gaussian | | Gaussian |
| | with standard | | with standard | | with standard |
| | deviation | | deviation | | deviation |
| | of 25 nm | | of 25 nm | | of 25 nm |
| Interlayer mirror | No | | No | | No |
| present | | | | | |
| Minor reflection | 570-830 | nm | 520-570 | nm | 340-510 nm |

| | | | |
|---|---|---|---|
| bands | | | |
| Mirror reflectivity | 95% | 95% | 95% |
| Transmission of | Peak = 90% | Peak = 90% | Peak = 90% |
| shutters | Minimum = 10% | Minimum = 10% | Minimum = 10% |

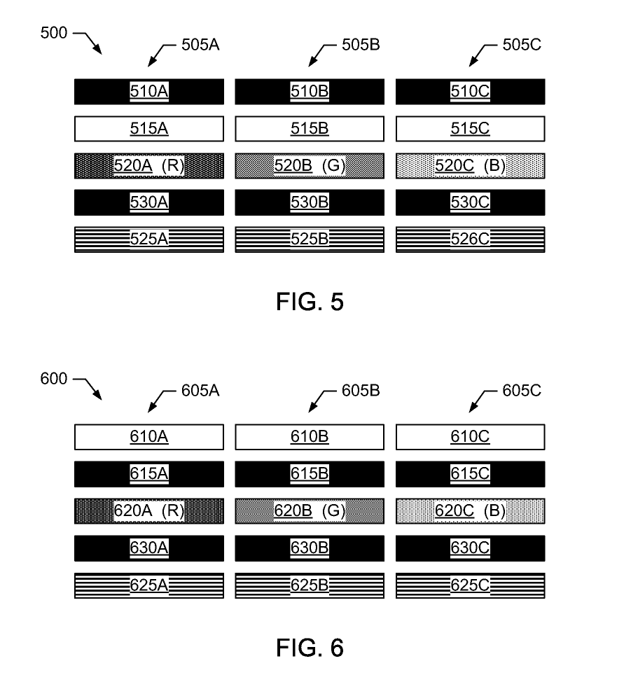

Fourth and fifth example sub-pixel arrangements 500 and 600 that may be used to implement the sub-pixel arrangement 115 of the display 105 are illustrated, respectively, in FIGS. 5 and 6. Similar to the sub-pixel arrangements 200 and 400 described above, the sub-pixel arrangements 500 and 600 include a luminescent layer (e.g., 520A-C and 620A-C, respectively) and a mirror layer (e.g., 525A-C and 625A-C, respectively) positioned interior to two active electro-optic shutter layers (e.g., black-clear shutter layers 510A-C and white-clear shutter layers 515A-C for the sub-pixel arrangement 500, and white-clear shutter layers 610A-C and black-clear shutter layers 615A-C for the sub-pixel arrangement 600). However, in contrast with the sub-pixel arrangements 200 and 400, the sub-pixel arrangements 500 and 600 each include an additional black-clear active electro-optic shutter layer (e.g., 530A-C and 630A-C, respectively) positioned between their respective luminescent and mirror layers to provide independently adjustable light transmission between the black (e.g., opaque) transmission state and the clear (e.g., transparent) transmission state (and possibly one or more intermediate light transmission states). In at least some examples, inclusion of the additional black-clear shutter layers 530A-C and 630A-C can increase the darkness of the darker color states and improve overall contrast relative to the sub-pixel arrangements 200 and 400.

In yet another example sub-pixel arrangement (not shown), each sub-pixel includes a respective luminescent layer positioned between two black-clear shutter layers. For example, such a sub-pixel arrangement could include an outermost black-clear shutter layer, followed by the luminescent layer, followed by another black-clear shutter layer, followed by an innermost mirror layer.

The preceding example sub-pixel arrangements can provide a several-fold increase in the perceived intensity of red light returned to a viewer per unit of sub-pixel area relative to purely reflective technologies because the red-emitting luminophores can absorb and utilize a wide range of wavelengths (e.g., such as green, blue and UV) that are unusable by the purely reflective technologies when producing red. The green-emitting luminophores in the preceding example sub-pixel arrangements also can provide a significant increase in the efficiency with which the available light is used because short wavelengths are converted to green wavelengths near the peak of the human photopic response (e.g., at 555 nm).

Additionally, although the luminescent layers included in the preceding example sub-pixel arrangements correspond to the primary colors red, green and blue, luminescent layers corresponding to other color combinations (e.g., such as cyan, yellow and magenta) can alternatively be used. Also, although optically down-converting luminophores are included in the luminescent layers of the preceding example sub-pixel arrangements, optically up-converting materials could additionally or alternatively be used to implement one or more the luminescent layers. Furthermore, although the preceding example sub-pixel arrangements have been described in the context of being used in the reflective display 105 of FIG. 1, the example sub-pixel arrangements can also be used in displays having their own light source. For example, any, some or all of the sub-pixel arrangements 200, 300, 400, 500 and/or 600 could be used to implement a display employing a front-light to replace or augment the available ambient light.

A block diagram of an example display control system 700 that may be used to control the display 105 when implemented using any of the sub-pixel arrangements 200, 300, 400, 500 and/or 600 is illustrated in FIG. 7. The display control system 700 of FIG. 7 includes a first example active matrix backplane 705 to generate a first matrix of electrical control signals (e.g., voltages and/or currents) such that a separate control signal is generated to set the light transmission state for the black-clear shutter layer in each sub-pixel included in each pixel of the display 105. (If the sub-pixel arrangements 500 or 600 are used to implement the display 105, two such active matrix backplanes 705 are included, in the display control system 700, one for each black-clear shutter layer included in the sub-pixel arrangement.) The display control system 700 of FIG. 7 also includes a second example active matrix backplane 710 to generate a second matrix of electrical control signals (e.g., voltages and/or currents) such that a separate control signal is generated to set the light transmission for the white-clear shutter layer in each sub-pixel included in each pixel of the display 105. Any type of active matrix backplane configuration can be used to implement the first and second active matrix backplanes 705-710. Alternatively, any type of passive matrix control can be used instead of either or both of the active matrix backplanes 705-710.

An example display controller 715 is included in the display control system 700 to determine the desired color state for each sub-pixel of each pixel of the display 105 and to appropriately control the first and second active matrix backplanes 705-710 to achieve the desired sub-pixel color states. In the illustrated example, the display controller 715 includes an example sub-pixel color state identifier 720 to identify the color state of each sub-pixel of each pixel of the display 105 based on the information (e.g., text, images, video, etc.) to be displayed via the display 105. For example, and, as described above, possible color states of a sub-pixel include a black state (or black reflecting state), a white state (or white reflecting state) and a primary color state (e.g., corresponding to the particular primary color of the sub-pixel, such as red, green or blue). In examples in which the black shutter layers and/or white shuttle layers support intermediate states between their fully closed and fully open states, a sub-pixel may have multiple primary color states, each associated with a different tint or shade of the primary color of the sub-pixel.

The color state of a particular sub-pixel is identified by the sub-pixel color state identifier 720 based on the overall color (including black or white) to be presented by the pixel that includes that sub-pixel. For example, if a particular pixel of the display 105 is to be black (e.g., such as in the examples of FIGS. 2A and 4A), then the identified color states for all sub-pixels in that pixel are black. Similarly, if the particular pixel is to be white (e.g., such as in the examples of FIGS. 2B and 4B), then the identified color states for all sub-pixels in that pixel arc white. However, if the particular pixel is to be one of the primary colors supported by one of the sub-pixels in the particular pixel (e.g., such as in the examples of FIGS. 2C, 2D and 4C) or if the particular pixel is to be a combination of such colors (e.g., such as in the examples of FIGS. 2E, 4D and 4E), then one or more of the sub-pixels in the pixel will be set to their respective primary color states, and the remaining sub-pixels will be set to the black state or white state, as appropriate.

The example display controller 715 also includes an example black shutter layer controller 725 and an example white shutter layer controller 730 to control the black-clear and white-clear shutter layers of each sub-pixel of the display 105 to achieve the desired color state identified by the sub-pixel color state identifier 720. For example, based on the sub-pixel color states identified by the sub-pixel color state identifier 720, the black shutter layer controller 725 issues commands and/or sets control signals to cause the first active matrix backplane 705 to open or close each sub-pixel's black-clear shutter layer to achieve the identified color state. Similarly, based on the sub-pixel color states identified by the sub-pixel color state identifier 720, the white shutter layer controller 730 issues commands and/or sets control signals to cause the second active matrix backplane 710 to open or close each sub-pixels white-clear shutter layer to achieve the identified color state.

While an example manner of implementing the display control system 700 has been illustrated in FIG. 7, one or more of the elements, processes and/or devices illustrated in FIG. 7 may be combined, divided, re-arranged, omitted, eliminated and/or implemented in any other way. Further, the first example active matrix backplane 705, the second example active matrix backplane 710, the example display controller 715, the example sub-pixel color state identifier 720, the example black shutter layer controller 725, the example white shutter layer controller 730 and/or, more generally, the example display control system 700 of FIG. 7 may be implemented by hardware, software, firmware and/or any combination of hardware, software and/or firmware. Thus, for example, any of the first example active matrix backplane 705, the second example active matrix backplane 710, the example display controller 715, the example sub-pixel color state identifier 720, the example black shutter layer controller 725, the example white shutter layer controller 730 and/or, more generally, the example display control system 700 could be implemented by one or more circuit(s), programmable processor(s), application specific integrated circuit(s) (ASIC(s)), programmable logic device(s) (PLD(s)) and/or field programmable logic device(s) (FPLD(s)), etc. Further still, the example display control system 700 of FIG. 7 may include one or more elements, processes and/or devices in addition to, or instead of those illustrated in FIG. 7, and/or may include more than one of any or all of the illustrated elements, processes and devices.

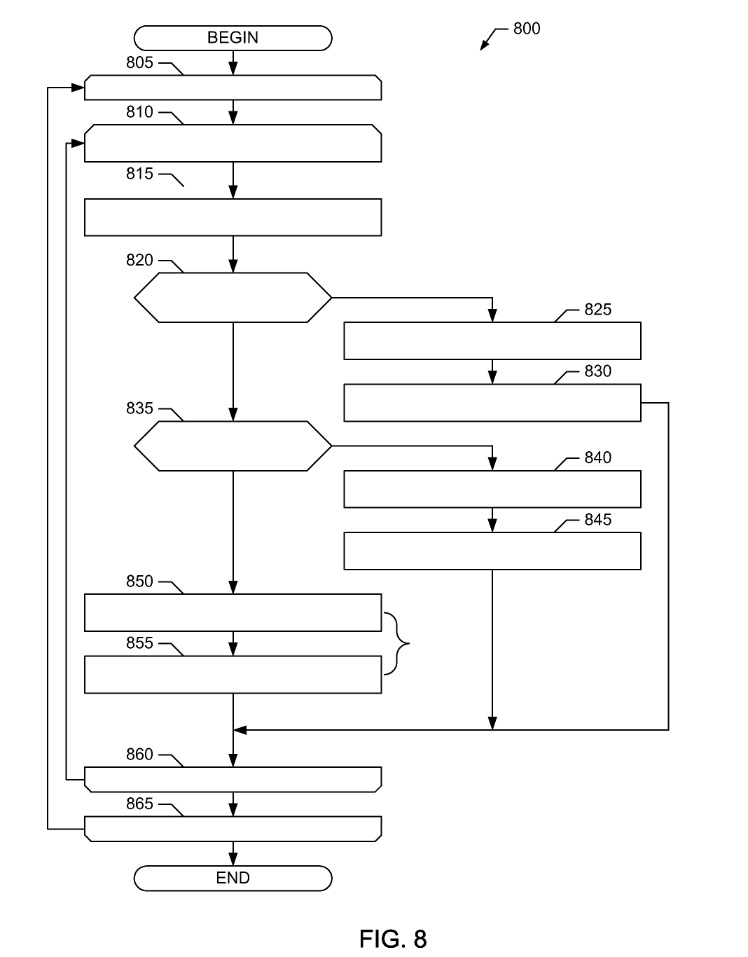

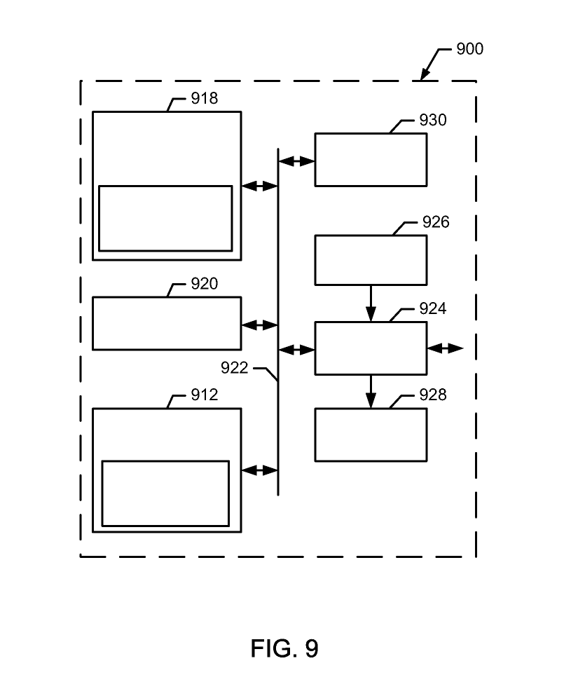

A flowchart representative of an example process that may be executed to implement any, some or all of the example display control system 700, the first example active matrix backplane 705, the second example active matrix backplane 710, the example display controller 715, the example sub-pixel color state identifier 720, the example black shutter layer controller 725 and the example white shutter layer controller 730 is shown in FIG. 8. In the illustrated example, the process represented by the flowchart may be implemented by one or more programs comprising machine readable instructions for execution by: (a) a processor, such as the processor 912 shown in the example processing system 900 discussed below in connection with FIG. 9, (b) a controller, and/or (c) any other suitable device. The one or more programs may be embodied in coded instructions stored on a tangible machine readable medium such as a flash memory, a read-only memory (ROM), and/or a random-access memory (RAM) associated with a processor or controller, such as the processor 912. As used herein, the term tangible machine readable medium (or tangible computer readable medium) is expressly defined to include any type of machine (e.g., computer readable storage and to exclude propagating signals. Additionally, or alternatively, the example process represented by the flowchart of FIG. 8 may be implemented using coded instructions (e.g., computer readable instructions) stored on a non-transitory machine (e.g., computer) readable medium, such as a flash memory, a ROM, a RAM, a cache, or any other storage media in which information is stored for any duration (e.g., for extended time periods, permanently, brief instances, for temporarily buffering, and/or for caching of the information). As used herein, the term non-transitory machine readable medium (or non-transitory computer readable medium) is expressly defined to include any type of machine (e.g., computer) readable medium and to exclude propagating signals.

The entire program or programs and/or portions thereof implementing the process represented by the flowchart of FIG. 8 could alternatively be executed by a device other than the processor 912 and/or embodied in any combination of firmware and/or hardware (e.g., such as any combination of ASIC(s), PLD(s), FPLD(s), discrete logic, etc.). Also, at least some of the process represented by the flowchart of FIG. 8 may be implemented manually. Further, many other techniques for implementing the example methods and apparatus described herein may be used as an alternative to the process represented by the flowchart of FIG. 8. For example, with reference to the flowchart illustrated in FIG. 8, the order of execution of the blocks may be changed, and/or some of the blocks described may be changed, eliminated, combined, and/or subdivided into multiple blocks.

An example process 800 that may be executed to implement the display control system 700 of FIG. 7 is represented by the flowchart shown in FIG. 8. The example process 800 may be executed at predetermined intervals (e.g., based on the refresh rate of the display 105), based on an occurrence of predetermined event(s) (e.g., such as an indication that the display 105 is to be refreshed), etc., or any combination thereof. With reference to FIG. 7, the process 800 of FIG. 8 begins execution at blocks 805 and 810 at which the display controller 715 begins iterating through each pixel (block 805) and each sub-pixel of each pixel (block 810) of the reflective display 105. For each sub-pixel, the sub-pixel color state identifier 720 included in the display controller 715 identifies the color state of the sub-pixel based on, for example, the overall color (including black or white) to be presented by the pixel that includes that sub-pixel (block 815). For example, at block 815 the sub-pixel color state identifier 720 identifies the overall color to be presented by the pixel of the current iteration, and then identifies the corresponding sub-pixel arrangement (e.g., such as, but not limited to, one of the example sub-pixel arrangements illustrated in FIGS. 2A-E, 3, 4A-E, 5 or 6) that achieves the pixel's identified overall color. Once the sub-pixel arrangement for the current pixel is identified, the color states of each sub-pixel in the pixel are identifiable from the sub-pixel arrangement, as described above in connection with the example sub-pixel arrangements illustrated in FIGS. 2A-E, 3, 4A-E, 5 or 6,

If the color state identified at block 815 for the sub-pixel of the current iteration is the black state (block 820), then the black shutter layer controller 725 included in the display controller 715 issues one or more commands and/or sets one or more control signals to cause the first active matrix backplane 705 to close (e.g., set to the black/opaque transmission state) the sub-pixel's black-clear shutter layer to achieve the black state (block 825). Additionally, in at least some examples, the white shutter layer controller 730 included in the display controller 715 issues one or more commands and/or sets one or more control signals to cause the second active matrix backplane 710 to open set to the clear transmission state) the sub-pixel's white-clear shutter layer (block 830).

If however, the state identified at block 815 for the sub-pixel of the current iteration is the white state (block 835), then the white shutter layer controller 730 issues one or more commands and/or sets one or more control signals to cause the second active matrix backplane 710 to close (e.g., set to the white/scattering transmission state) the sub-pixel's white-clear shutter layer to achieve the white state (block 840). Additionally, in at least some examples, the black shutter layer controller 725 issues one or more commands and/or sets one or more control signals to cause the first active matrix backplane 705 to open (e.g., set to the clear transmission state) the sub-pixel's black-clear shutter layer (block 845).

However, if the state identified at block 815 for the sub-pixel of the current iteration is neither the black state (block 820) nor the white state (block 835), then the black shutter layer controller 725 issues one or more commands and/or sets one or more control signals to cause the first active matrix backplane 705 to open (e.g., set to the clear transmission state) the sub-pixel's black-clear shutter layer (block 850). Additionally, the white shutter layer controller 730 issues one or more commands and/or sets one or more control signals to cause the second active matrix backplane 710 to open (e.g., set to the clear transmission state) the sub-pixel's white-clear shutter layer (block 855). The processing at blocks 850 and 855 causes the shutter layers included in the sub-pixel of the current iteration to allow the sub-pixel's luminescent and minor layers to reflect and emit light corresponding to the color of the sub-pixel,

Next, the display controller 715 continues iterating through each sub-pixel (block 860) and each pixel (block 865) of the display 105. After iteration through all pixels and associated sub-pixels completes, execution of the process 800 ends.

Although not shown in FIG. 8, in some examples, the process 800 can include one or more decision blocks in addition, or as an alternative, to blocks 820 and 835 to enable each sub-pixel's black-clear shutter layer to be set to one or more intermediate light transmission states between the clear state and the black state. Additionally or alternatively, the process 800 can include one or more decision blocks in addition or as an alternative, to blocks 820 and 835 to enable each sub-pixel's white-clear shutter layer to be set to one or more intermediate light transmission states between the clear state and the white state.

FIG. 9 is a block diagram of an example processing system 900 capable of implementing the apparatus and methods disclosed, herein. The processing system 900 can be, for example, a server, a personal computer, a PDA, an e-book reader, a smartphone, an Internet appliance, a DVD player, a CD player, a digital video recorder, a personal video recorder, a set top box, or any other type of computing device.

The system 900 of the instant example includes a processor 912 such as a general purpose programmable processor. The processor 912 includes a local memory 914, and executes coded instructions 916 present in the local memory 914 and/or in another memory device. The processor 912 may execute, among other things, machine readable instructions to implement at least portions of the process represented in FIG. 8. The processor 912 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors, one or more microcontrollers from the ARM® family of microcontrollers, the PIC® family of microcontrollers, etc. Of course, other processors and/or microcontrollers from other families are also appropriate.

The processor 912 is in communication with a main memory including a volatile memory 918 and a non-volatile memory 920 via a bus 922. The volatile memory 918 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 920 may be implemented by flash memory and/or any other desired type of memory device. Access to the main memory 918, 920 is typically controlled by a memory controller (not shown).

The processing system 900 also includes an interface circuit 924. The interface circuit 924 may be implemented by any type of interface standard, such as an Ethernet interface, a universal serial bus (USB), and/or a third generation input/output (3GIO) interface.

One or more input devices 926 are connected to the interface circuit 924. The input device(s) 926 permit a user to enter data and commands into the processor 912. The input device(s) can be implemented by, for example, a keyboard, a mouse, a touchscreen, a track-pad, a trackball, an isopoint and/or a voice recognition system.

One or more output devices 928 are also connected to the interface circuit 924. The output devices 928 can be implemented, for example, by display devices a liquid crystal display, a cathode ray tube display (CRT)), by a printer and/or by speakers. The interface circuit 924, thus, typically includes a graphics driver card.

The interface circuit 924 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The processing system 900 also includes one or more mass storage devices 930 for storing software and data. Examples of such mass storage devices 930 include floppy disk drives, hard drive disks, compact disk drives and digital versatile disk (MID) drives.

As an alternative to implementing the methods and/or apparatus described herein in a system such as the processing system of FIG. 9, the methods and or apparatus described herein may be embedded in a structure such as a processor and/or an ASIC (application specific integrated circuit).

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A sub-pixel for a reflective display, the sub-pixel comprising:
a first active shutter layer to provide a first adjustable light transmission;
a second active shutter layer to provide a second adjustable light transmission, the first and second active shutter layers being independently controllable; and
a luminescent layer positioned interior to at least one of the first and second active shutter layers, the luminescent layer to emit light having a color corresponding to the sub-pixel.

2. A sub-pixel as defined in claim 1 wherein the first active shutter layer is adjustable between a first clear state corresponding to the first active shutter layer being substantially transparent and a black state corresponding to the first active shutter layer being substantially opaque, and the second active shutter layer is adjustable between a second clear state corresponding to the second active shutter layer being substantially transparent and a white state corresponding to the second active shutter layer being substantially light scattering.

3. A sub-pixel as defined in claim 2 wherein the first active shutter layer is adjustable to an intermediate state between the first clear state and the black state.

4. A sub-pixel as defined in claim 2 wherein the second active shutter layer is positioned interior to the first active shutter layer, and the luminescent layer is positioned interior to the first and second active shutter layers.

5. A sub-pixel as defined in claim 2 wherein the first active shutter layer is positioned interior to the second active shutter layer, and the luminescent layer is positioned interior to the first and second active shutter layers.

6. A sub-pixel as defined in claim 1 wherein the first active shutter layer is adjustable between a first clear state corresponding to the first active shutter layer being substantially transparent and a first black state corresponding to the first active shutter layer being substantially opaque, the second active shutter layer is adjustable between a second clear state corresponding to the second active shutter layer being substantially transparent and a second black state corresponding to the second active shutter layer being substantially opaque, and the luminescent layer is positioned between the first and second active shutter layers.

7. A sub-pixel as defined in claim 1 further comprising a mirror layer positioned interior to the luminescent layer, the mirror layer to:
reflect light passing through the first active shutter layer, the second active shutter layer and the luminescent layer; and
reflect light emitted by the luminescent layer.

8. A sub-pixel as defined in claim 7 wherein the mirror layer comprises at least one of a wavelength selective mirror, or a combination of a color filter and a broadband mirror.

9. A sub-pixel as defined in claim 1 wherein at least one of the first active strutter layer or the second active shutter layer is an electro-optic shutter layer comprising at least one of a an electrophoretic (EP) system containing broadband scattering particles, an electro-wetting layer containing broadband scattering particles or an electrofluidic layer containing broadband scattering particles.

10. A sub-pixel as defined in claim 1 wherein the luminescent layer comprises luminophores to absorb light in a first band of wavelengths and emit light in a second band of wavelengths, the second band of wavelengths related to the color corresponding to the sub-pixel, the first band of wavelengths being different from the second band of wavelengths.

11. A reflective display comprising:
a first sub-pixel comprising:
a first active shutter layer to provide a first adjustable light transmission;
a second active shutter layer to provide a second adjustable light transmission;
a first luminescent layer positioned interior to at least one of the first and second active shutter layers, the luminescent layer comprising first luminophores to emit light having a first color corresponding to the first sub-pixel; and
a first mirror layer positioned interior to the first luminescent layer; and
a second sub-pixel comprising:
a third active shutter layer to provide a third adjustable light transmission;
a fourth active shutter layer to provide a fourth adjustable light transmission;
a second luminescent layer positioned interior to at least one of the third and fourth active shutter layers, the second luminescent layer comprising second luminophores to emit light having a second color corresponding to the second sub-pixel; and
a second mirror layer positioned interior to the second luminescent layer.

12. A reflective display as defined in claim 11 further comprising a third sub-pixel comprising:
a fifth active shutter layer to provide a fifth adjustable light transmission;
a sixth active shutter layer to provide a sixth adjustable light transmission; and
a color-reflecting interlayer mirror positioned between the fifth active shutter layer and the sixth active shutter layer.

13. A reflective display as defined in claim 12 wherein the first active shutter layer, the third active shutter layer and the fifth active shutter layer are independently adjustable between a first clear state and a black state, and the second active shutter layer, the fourth active shutter layer and the sixth active shutter layer are independently adjustable between a second clear state and a white state.

14. A method to control a reflective display comprising a plurality of pixels, each pixel comprising a respective plurality of sub-pixels, the method comprising:
identifying a color state associated with a sub-pixel;
setting a first active shutter layer included in the sub-pixel to a first light transmission state based on the determined color state associated with the sub-pixel; and
setting a second active shutter layer included in the sub-pixel to a second transmission state based on the determined color state associated with the sub-pixel, the second active shutter layer being different from the first active shutter layer.

15. A method as defined in claim 14 further comprising
determining whether the color state associated with the sub-pixel is at least one of white or black;
when the color state is white, setting the first active shutter layer to a first clear transmission state and the second active shutter layer to a light scattering transmission state;
when the color state is black, setting the first active shutter layer to an opaque transmission state and the second active shutter layer to a second clear transmission state; and
when the color state is neither black nor white, setting the first active shutter layer to the first clear transmission state and the second active shutter layer to the second clear transmission state.
